(19) United States
(12) Patent Application Publication
(10) Pub. No.: US 2026/0121771 A1
(43) Pub. Date: Apr. 30, 2026

(54) Common Phase Error Handling in Wireless Communication

(71) Applicant: TP-LINK SYSTEMS, INC., Irvine, CA (US)

(72) Inventors: Qiaoyang Ye, San Jose, CA (US); Jian Gu, San Jose, CA (US)

(73) Assignee: TP-LINK SYSTEMS, INC., Irvine, CA (US)

(21) Appl. No.: 18/926,961

(22) Filed: Oct. 25, 2024

(51) Int. Cl. H04B 17/27; H04W 84/12

(52) U.S. Cl. CPC H04B 17/27; H04W 84/12

(57) ABSTRACT

In some embodiments, a receiver in wireless communication may decode signals received from a wireless communication network. The receiver may include a common phase error (CPE) estimator configured to estimate a respective phase for each of a plurality of symbols received from the wireless network over a plurality of subcarriers. For a symbol of the plurality of symbols, the receiver may determine a combined CPE based in part on estimated phases of one or more other symbols of the plurality of symbols. The apparatus may compensate phases of the plurality of symbols by the combined CPE before the plurality of symbols are decoded by a decoder. In some embodiments, when combining the CPEs of plurality of symbols, the phase of each symbol is offset by a respective carrier frequency offset (CFO). The receiver may be an orthogonal frequency-division multiplexing (OFDM) receiver.

### FIELD

This technology relates to wireless communication network, and more particularly to apparatuses and methods for common phase error estimation.

### BACKGROUND

Wireless local area network (WLAN) protocols, such as Institute for Electrical and Electronics Engineers (IEEE) 802.11, allow for various devices (stations) to communicate with each other in a wireless communication network. Whereas the protocols specify the signaling in over the air (OTA) medium, many underlying implementation details in devices are left to the device manufacturers. For example, common phase error (CPE) is a type of phase distortion that occurs in communication systems. In receiving wireless signals, a receiver device receiving data from the OTA medium may need to estimate CPE for the symbols received and compensate the received symbols by the estimated CPE before decoding them. CPE estimation can be left for the device manufacturers to implement, for example, in physical (PHY) layer.

### SUMMARY

The present disclosure relates to techniques for improving the performance of common phase error estimation in decoding signals received from a wireless communication network. In an embodiment, the techniques provide an apparatus that includes: a common phase error (CPE) estimator configured to estimate a respective phase for each of a plurality of symbols received from the wireless network over a plurality of subcarriers; a CPE combiner coupled to the CPE estimator and configured to, for a symbol of the plurality of symbols, determine a combined CPE based in part on estimated phases of one or more other symbols of the plurality of symbols; and a CPE compensation unit coupled to the CPE estimator and configured to compensate phases of the plurality of symbols by the combined CPE.

In an embodiment, the techniques provide a method for common phase error estimation that includes: estimating a respective phase for each of a plurality of symbols received from the wireless network over a plurality of subcarriers; for a symbol of the plurality of symbols, determining a combined CPE based in part on estimated phases of one or more other symbols of the plurality of symbols; and compensating phases of the plurality of symbols by the combined CPE.

### BRIEF DESCRIPTION OF DRAWINGS

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1 illustrates a wireless communication network, according to some embodiments.

FIG. 2 is a schematic diagram of an example system for common phase error estimation, according to some embodiments.

FIG. 3 is a schematic diagram of an OFDM receiver that implements various embodiments of common phase error estimation, according to some embodiments.

FIG. 4 is a flow diagram of an example process for estimating common phase error, according to some embodiments.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the invention is thereby intended. It should be further appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

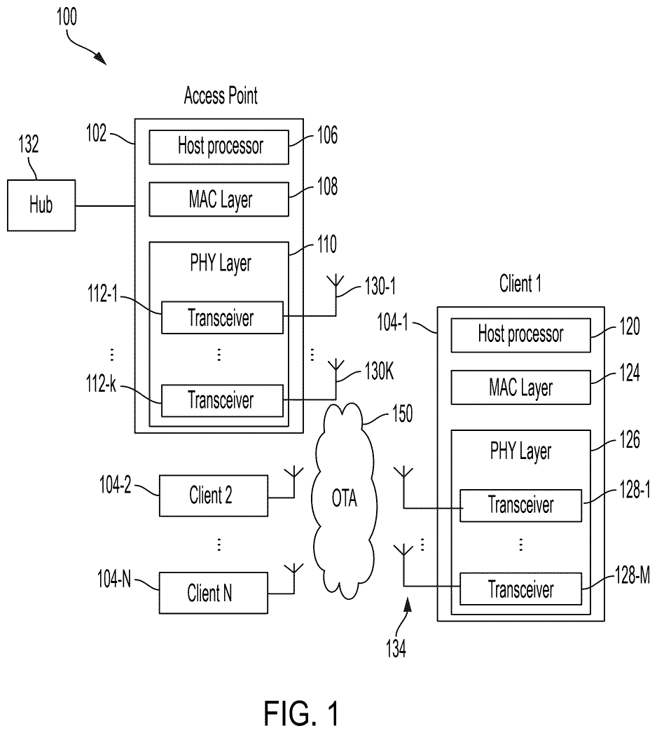

FIG. 1 illustrates a wireless communication network, according to some embodiments. In some embodiments, a wireless communication network 100 (e.g., WLAN) may facilitate communications between one or more access point (AP) device (e.g., 102) and one or more client devices (e.g., 104-1, 104-2, . . . 104-N). Each of the AP and client devices may be configured to receive or transmit frames (packets) from/to another device (e.g., AP or client devices) via over the air (OTA) medium (e.g., 150). These communication devices may be communicating with each other in a communication protocol, e.g., IEEE 802.11, or other suitable wireless protocols.

As shown in FIG. 1, AP device 102 may include one or more antennas (e.g., 130-1, . . . 130-K) configured to transmit or receive radio frequency (RF) signals to/from other devices in the wireless communication network 100. AP device 102 may include a physical layer 110, a MAC layer 108, and a host processor 106, which are configured to generate or process RF signals in lower to upper network layers, respectively. For example, PHY 110 may be configured to implement physical layer functions. PHY 110 may also include one or more transceivers (e.g., 112-1, . . . 112-K) configured to convert between baseband signals and RF signals, where RF signals are transmitted or received via the one or more antennas, e.g., 130-1, . . . 130-K. In a non-limiting example, in 802.11, PHY 110 may be configured to receive wireless frames, e.g., MPDU (MAC protocol data unit) from the MAC processor, remove the preamble and PHY header and extract the baseband signals. Similarly, PHY 110 may add preamble and PHY header to the baseband signals to generate wireless frames (packets), e.g., MPDUs, for passing to the MAC layer.

In FIG. 1, the MAC 108 may be configured to implement MAC layer functions including processing frames (packets) received from the PHY layer and converting to data frames for upper layer(s), or vice versa. For example, in 802.11, the MAC 108 may extract MSDUs (MAC service data unit) payload encapsulated in the frame body of MPDUs for the upper layers, where MPDUs are received from the PHY layer. Similarly, MAC 108 may receive MSDUs from upper layers and convert them to MPDUs for the PHY layer. Host processor 106 may be coupled to MAC 108 and PHY 110 to process data via respective layers. Host processor 106 may also be configured to implement one or more applications and transmit/receive data to/from MAC 108.

As shown in FIG. 1, each of the components, e.g., host processor 106, MAC 108, PHY 110, as well as transceivers (112-1, . . . 112-K) may include circuitry, e.g., one or more integrated circuits (ICs). Thus, one or more functions of MAC and PHY layers may be implemented in hardware. Alternatively, and/or additionally, one or more functions of MAC and PHY layers may be implemented in software, e.g., via executing programing instructions (e.g., stored in memory). For example, each of the MAC 108 and PHY 110 may include one or more processors, e.g., CPUs, to execute programming instructions in a memory.

With further reference to FIG. 1, AP device 102 may be connected to a hub 132 (e.g., a wired router, a modem) which provides the Internet services (e.g., via an ISP). AP device 102 may provide Internet, via hub 132, to one or more client devices (e.g., 104-1, 104-2, . . . 104-N) that are connected to the AP device wirelessly, e.g., via OTA medium 150. Each of the client devices may have a similar configuration as the AP device 102. For example, client device 104-1 may include a host processor 120, a MAC layer 124, a PHY layer 126.

Similar to AP device 102, a client device (e.g., 104-1, 104-2, . . . 104-N) may include one or more antennas (e.g., 134) configured to transmit or receive RF signals to/from other devices in the wireless communication network 100. PHY layer 126, MAC layer 124, and host processor 120 may be configured to generate or process RF signals in lower to upper network layers, respectively. For example, PHY layer 126 may be configured to implement physical layer functions. PHY layer 126 may include one or more transceivers (e.g., 128-1, . . . 128-M) configured to convert between baseband signals and RF signals, where RF signals are transmitted or received via the one or more antennas 134. In a non-limiting example, in 802.11, PHY layer 126 may receive wireless frames, e.g., MPDUs from the MAC layer 124, remove the preamble and PHY header and extract the baseband signals. Similarly, PHY 126 may add preamble and PHY header to the baseband signals to generate wireless frames (packets), e.g., MPDUs, for passing to MAC layer 124.

In FIG. 1, MAC layer 124 may be configured to implement MAC layer functions including processing frames (packets) received from the PHY layer and converting to data frames for upper layer(s), or vice versa. For example, in 802.11, MAC layer may extract MSDUs payload encapsulated in the frame body of MPDUs for the upper layers, where MPDUs are received from the PHY layer. Similarly, MAC layer 124 may receive MSDUs from the upper layers and convert them to MPDUs for the PHY layer. Host processor 120 may be coupled to the MAC layer 124 and PHY layer 126 to process data via respective layers. Host processor 120 may also be configured to implement one or more applications and transmit/receive data to/from MAC layer 124.

Similar to AP device 102, each of the components in a client device, e.g., host processor 120, MAC layer 124, PHY layer 126, as well as transceivers (128-1, . . . 128-M) may include circuitry, e.g., one or more integrated circuits (ICs). Thus, one or more functions of MAC and PHY layers may be implemented in hardware. Alternatively, and/or additionally, one or more functions of MAC and PHY layers may be implemented in software, e.g., via executing programing instructions (e.g., stored in memory) by MAC layer 124, PHY layer 126, host processor 120, or any other suitable processors. Client devices 104-2, . . . 104-N may each have a similar configuration as client device 104-1. Although one AP device 102 is shown in FIG. 1, it is appreciated that there can be multiple AP devices in the wireless communication network 100. Further, any suitable number of client device may be possible as supported in current or later developed protocols.

Any device in the wireless network 100 (e.g., 102, 104) may decode data (which may include a sequence of symbols) received from the OTA medium. Data received from the OTA medium may include common phase error (CPE). For example, in OFDM network, there may exist phase shift of the subcarriers due to mismatch between the transmitter and receiver oscillator phases. CPE may be caused by phase noise, and frequency offset between a transmitter and a receiver. In some examples, CPE may affect all the frequencies in one symbol in the same manner, which can be seen as a constellation rotation. It may degrade the system performance and increase the packet error rate.

In some existing systems, for example, in OFDM network, CPE may be estimated for each symbol by using symbols received on pilot subcarriers (e.g., 4, 6, 8, or any suitable number of pilot subcarriers or frequencies), where the estimated CPE may be applied to the symbol received at other subcarriers (e.g., data subcarriers). The inventors have appreciated and acknowledged that CPE estimation may not be accurate under certain network conditions (e.g., when signal-to-noise ratio is low) because only limited number of subcarriers (e.g., four subcarriers) are defined and can be used. For example, four pilot subcarriers are commonly used under some wireless protocols.

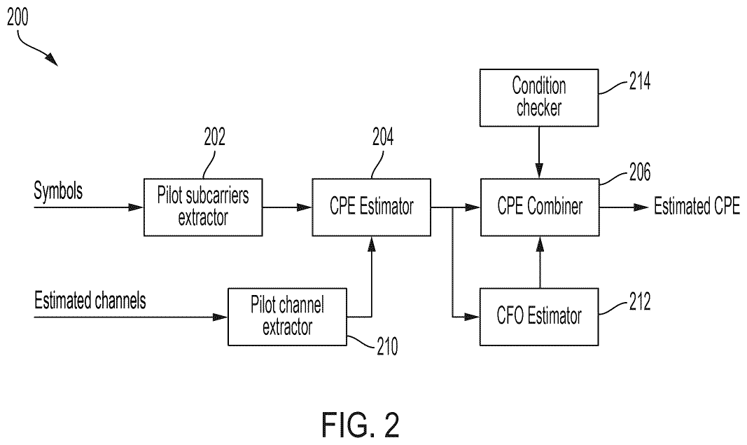

Accordingly, the inventors have developed techniques that estimate CPE for a symbol additionally based on estimated CPEs of one or other symbols, such as neighboring symbols. In a simple scenario, CPE for one symbol may be determined based on combining the estimated CPEs for that symbol and the preceding symbol, for example, by averaging. This effectively uses information on more subcarriers. For example, CPE is estimated based on information on four subcarriers for the current symbol and four additional subcarriers for the preceding symbol. As a result, the accuracy of CPE estimation is improved. In some scenarios, to estimate CPE for a symbol, estimated CPEs for a plurality of previous symbols may be used. Details of the techniques are further described with reference to FIGS. 2-4.

FIG. 2 is a diagram of an example system 200 for common phase error estimation, according to some embodiments. System 200 may be implemented in any of the devices shown in FIG. 1. For example, system 200 may be implemented in the PHY layer of a device. In some embodiments, system 200 may include a common phase error (CPE) estimator 204 configured to estimate a respective phase for each of a plurality of symbols received from the wireless network, and a CPE combiner 206 coupled to the CPE estimator 204 and configured to, for a symbol of the plurality of symbols, determine a combined CPE based in part on estimated phases of one or more other previous symbols. A previous symbol may be received at a time prior to the current symbol. In some examples, in combining the plurality of symbols, a weighted average may be used.

In some embodiments, the number of the one or more previous symbols for combining may be determined based on a signal-to-noise ratio (SNR) and/or modulation and coding scheme index (MCS). MCS may indicate the quality of the wireless connection between two stations, which may depend on one or more of modulation type, coding rate, the number of spatial streams, the channel width, and the guard interval. SNR may be estimated for a packet of multiple symbols. For example, SNR may be estimated based on long training field (LTF). In some examples, for a higher SNR, fewer symbols may be combined to estimate the common phase error, and conversely, for a lower SNR, more symbols may be combined to estimate the common phase error.

In FIG. 2, CPE estimator 204 may be provided with a plurality of symbols and estimated channels over a plurality of subcarriers. System 200 may further include a pilot subcarrier extractor 202 coupled to the CPE estimator 204 and configured to extract the received symbols on pilot subcarriers and data subcarriers. Pilot subcarriers are used to transmit known training symbols (known by both the transmitter and the receiver) to the receiver, whereas data subcarriers are used to transmit wireless data to the receiver. In non-limiting examples, for a given wireless protocol, the number of pilot subcarriers may be eight, whereas the number of data subcarriers may be hundreds.

System 200 may further include a pilot channel extractor 210 coupled to the CPE estimator 204 and configured to extract estimated channels on pilot subcarriers and data subcarriers. In some examples, a channel may be a complex scaling number that represents the channel for each of the receiver antennas per subcarrier. Channel estimation may be provided using any suitable channel estimators, such as the techniques described in the U.S. patent application Ser. No. 18/790,649, titled CHANNEL AND NOISE ESTIMATION IN WIRELESS COMMUNICATION, which is incorporate by reference herein.

In CPE estimator 204, CPE may be estimated based on pilot subcarriers or data subcarriers. For example, for pilot subcarriers-based estimation, CPE may be estimated based at least in part on impact of channels over pilot subcarriers and the symbol over pilot subcarriers (e.g., pilot sequence) being removed. Similarly, for data subcarriers-based estimation, CPE may be estimated based at least in part on impact of channels over data subcarriers and the symbol over data subcarriers being removed. Additionally and/or alternatively, CPE may be estimated based on a combination of pilot subcarriers-based estimate and a data subcarriers-based estimate, e.g., average of the two.

Returning to CPE combiner 206, the inventors have acknowledged and appreciated that phase rotations may exist amongst the plurality of symbols to be combined. Phase rotation may be caused by a mismatch in frequency, referred to carrier frequency offset (CFO), where the oscillators in the transmitter and receiver radios do not run at the exact same frequency. CFO may accumulate over time, for example, over a sequence of symbols. Accordingly, the inventors have developed techniques that estimate CFO and offset the phase of each symbol by a respective CFO before combining phases of the plurality of symbols.

In some embodiments, system 200 may further include a CFO estimator 212 coupled to the CPE combiner 206 and configured to estimate CFO for each of the symbols to be used by the CPE combiner 206. In some examples, CFO for a symbol may be estimated based at least on a phase difference between the symbol and a previous symbol and a time elapsed between the symbol and the previous symbol.

A phase difference between two symbols may be estimated in a similar manner as CPE is estimated. For example, a phase difference between two symbols may be estimated based on pilot subcarriers or data subcarriers. For pilot subcarriers-based estimation, phase difference may be estimated based at least in part on impact of channels over pilot subcarriers and the symbols over pilot subcarriers (e.g., pilot sequence) being removed. Similarly, for data subcarriers-based estimation, phase difference may be estimated based at least in part on impact of channels over data subcarriers and the symbols over data subcarriers being removed. In a similar manner as described in CPE estimator 204, the channels used for estimating the phase difference of two symbols may be provided by any suitable channel estimation techniques. Additionally and/or alternatively, phase difference between two symbols may be estimated based on a combination of pilot subcarriers-based estimate and a data subcarriers-based estimate, e.g., average of the two.

Having described the estimation of a phase difference between the current symbol and the previous symbol, CFO for the current symbol may be estimated on the phase difference between the two symbols divided by a time duration between the two symbols (e.g., the time elapsed between the current symbol and the previous symbol). In some examples, selection of the previous symbol may be determined based on a distance in time (e.g., the number of symbols arriving in a sequence) between the current symbol and the previous symbol in comparison to a threshold distance. The threshold distance may be determined on one or more network conditions. For example, the previous symbol may be selected such that a number of symbols between the symbol and the previous symbol is proportionally based on a signal-to-noise ratio or modulation and coding scheme index (MCS).

In some embodiments, CFO for a current symbol may be determined additionally based a combination of estimated CFO of another symbol. In a non-limiting scenario, CFO for a symbol may be obtained by averaging across multiple symbols prior to the current symbol.

Having described various components in system 200, it is appreciated that CPE combiner 206 may be optional. For example, when one or more network conditions are met, CPE combiner 206 may not be needed. In non-limiting examples, system 200 may include a condition checker 214 coupled to CPE combiner 206 and configured to determine whether one or more channel conditions in the wireless network are met (for example, whether SNR exceeds a threshold). In response to determining that one or more channel conditions in the wireless network are met (e.g., SNR exceeds a threshold) or not met, system 200 may determine to bypass the CPE combiner 206. Instead, CPE estimated at a symbol (in CPE estimator 204) can be used to compensate the data subcarriers in the same symbol.

Now, various components in FIG. 2 are further described in detail. In some embodiments, the various components, e.g., boxes 204, 206, 214, 216, may operate in a frequency domain. Thus, system 200 may receive one or more training symbols and other signals in frequency domain, where the training symbols and frequency domain signals may be provided by a time to frequency converter, e.g., Fast Fourier Transform (FFT) unit. Although the examples that follow will be illustrated in frequency domain, it is appreciated that system 200 may alternatively operate in time domain.

In some embodiments, the received signals (e.g., in frequency domain) may include a plurality of symbols and may be separated into signals on pilot subcarriers and signals on data subcarriers, for example, by pilot subcarriers extractor (202 in FIG. 2). The estimated channels may also be separated into the channels on pilot subcarriers and channels on data subcarriers, for example, by pilot channel extractor (210 in FIG. 2). The received signals on pilot subcarriers and the estimated channels on pilot subcarriers can be used for CPE estimation, such as CPE estimator 204 described in FIG. 2.

Denoting the received signals on pilot subcarrier k on receiver antenna j at symbol m by y_{m,j}[k], the estimated channels on pilot subcarrier k on receiver antenna j on spatial-time-stream (STS) (by \tilde{h}_{l,j}[k], the pilot sequence on pilot subcarrier k on receiver antenna j on spatial-time-stream (STS) l by x_{l,m}[k], the CPE at the symbol m can be estimated by

$${\hat{φ}}_{{m}_{p}} = phase ( {z}_{m} ) \qquad ( 1 )$$

where zₘ is a complex number with noise whose phase corresponds to CPE. In some examples, CPE may be determined based on pilot-subcarriers with the impact from channel and the pilot sequence being removed. For example, zₘ may be expressed as

$${z}_{m} = \{ \begin{matrix}{\sum }_{j = 0}^{{N}_{RX} - 1} {\sum }_{k ∈ {K}_{pilot}} {y}_{m , j} [ k ] {\sum }_{l = 0}^{{N}_{STS} - 1} ( {\tilde{h}}_{l , j} [ k ] {{x}_{l , m} [ k ]}^{*} , & if m \geq 0 \\ 1 , & otherwise\end{matrix} , \qquad ( 2 )$$

where y_{m,j}[k] is the received pilot sequence on pilot subcarriers, and x_{l,m}[k] is the pilot sequence being transmitted and known (e.g., defined in a wireless protocol), and \tilde{h}_{l,j}[k] is the estimated channel response for each of the receiver antennas per subcarrier. In the Eq. (2), the multiplication of

$${\sum }_{l = 0}^{{N}_{STS} - 1} {( {\tilde{h}}_{l , j} [ k ] {x}_{l , m} [ k ] )}^{*}$$

is to remove the impact from the channel and the pilot sequence, where “*” stands for conjugate. N_{STS} indicates the number of STS which may be defined per wireless protocol. For example, STS may include two strings, in which case, N_{STS}=2. In some examples, such as for legacy preamble L-LTF (long training field), N_{STS}=1, where index l can be ignored. In some embodiments, different STSs may have the same pilot signal, e.g., in non-HT physical layer protocol data unit (PPDU), very high throughput (VHT) PPDU, or high efficiency (HE) PPDU. In these cases, the above STS may include one string, thus N_{STS}=1 and index l can be ignored.

In some embodiments, CPE may be determined based on data-subcarriers. For example, denote by \hat{x}_{m,j}[k] the signal reconstructed from the demodulated signal from received signal y_{m,j}[k] on receiver antenna j at symbol m. There can be various methods for mapping y_{m,j}[k] to \hat{x}_{m,j}[k], such as least square (LS) or minimum mean square error (MMSE) methods or any suitable method now known or later developed. Thus, CPE can be estimated by

$${\hat{φ}}_{{m}_{d}} = phase ( {z}_{m}^{′} ) \qquad ( 3 )$$

$${z}_{m}^{′} = {\sum }_{j = 0}^{{N}_{R x} - 1} {\sum }_{k ∈ {K}_{data}} {y}_{m , j} [ k ] {( {\sum }_{l = 0}^{{N}_{STS} - 1} {\tilde{h}}_{l , j} [ k ] {\hat{x}}_{m , j} [ k ] )}^{*} , \qquad ( 4 )$$

where K_{data} is the set of data subcarriers used for the data subcarriers-based estimation, and \tilde{h}_{l,j}[k] is the estimated channel response for each of the receiver antennas per subcarrier. K_{data} may include all of the data subcarriers, or a subset of the data subcarriers. In some examples, one or more selection rules, such as the signal power, the distance from the constellation point etc., can be used to select the subset of the data subcarriers. The multiplication of

$${( {\sum }_{l = 0}^{{N}_{STS} - 1} {\tilde{h}}_{l , j} [ k ] {\hat{x}}_{m , j} [ k ] )}^{*}$$

in Eq (4) above is to remove the impact from channel and transmitted signal, where “*” is conjugate. Comparing Eq. (4) to Eq. (2), it is shown that the data subcarriers-based estimation uses the reconstructed signal from received symbols, whereas the pilot subcarriers-based estimation uses known pilot sequence.

In some examples, either the phase \hat{φ}ₘ_{ₚ} estimated based on pilot subcarriers, or the phase \hat{φ}ₘ_{_{d}} estimated based on data subcarriers can be used, e.g., \hat{φ}ₘ=\hat{φ}ₘ_{ₚ} or \hat{φ}ₘ=\hat{φ}ₘ_{_{d}}. In other examples, the phase \hat{φ}ₘ_{ₚ} estimated based on pilot subcarriers and phase \hat{φ}ₘ_{_{d}} estimated based on data subcarriers can be combined. For example, CPE can be calculated by \hat{φ}ₘ=w_{d}\hat{φ}ₘ_{_{d}}+wₚ\hat{φ}ₘ_{ₚ}, where w_{d} and wₚ can be any non-negative number, e.g. 0, 0.2, 0.5, 0.8, or 1. In some examples, w_{d}+wₚ=1.

Now, CFO estimator (e.g. 212 in FIG. 2) is explained further with examples. As described above and further herein, the frequency offset (CFO) causes the phase rotation to change over time, where the phase rotation can be calculated by 2π\hat{Δ}ft. In estimating the frequency offset \hat{Δ}f, a phase difference between a symbol m and a previous symbol m−L may be used, where the time duration between these two symbols is proportional to the parameter L. The larger the L is, the larger the time duration between these two symbols and the larger the phase would rotate, based on the 2π\hat{Δ}ft.

In some embodiments, the phase difference between symbol m and previous symbol m−L, which is caused by CFO, can be calculated based on signals over pilot subcarriers. For example,

$${\hat{θ}}_{{m}_{p}} = phase ( {z}_{m} \times conj ( {z}_{m - L} ) ) , \qquad ( 5 )$$

where zₘ and z_{m-L} may be obtained in a similar manner as described in Eq. (2). L, referred to a tracking gap in terms of how many symbols between the current symbol and the previous symbol, can be any positive integer such as 1, 3, 5, etc. (symbols). L may be an empirical value. A higher value of L may provide a more accurate estimation. However, if it is too large (e.g., 10 symbols), the accumulated phase rotations caused by CFO may be over 2π, whereas the estimated value may be less than 2π (because a rotation of 2π and 0 can be treated the same in mathematical calculations), resulting in inaccurate estimation. In some examples, the value of L may be determined based on one or more network conditions. For example, the value of L may depend on the SNR and/or MCS, e.g., a larger value of L for high SNR/MCS and a lower value of L for low SNR/MCS.

Alternatively and/or additionally, in some embodiments, the phase difference between symbol m and previous symbol m−L may be calculated based on signals over data subcarriers. For example,

$${\hat{θ}}_{{m}_{d}} = phase ( {z}_{m}^{′} \times conj ( {z}_{m - L}^{′} ) ) , \qquad ( 6 )$$

where z′ₘ and z′_{m-L} may be obtained in a similar manner as described in Eq. (4).

In some examples, either pilot subcarriers-based phase estimation \hat{θ}ₘ_{ₚ} or data subcarriers-based phase estimation \hat{θ}ₘ_{_{d}} can be used for CFO estimation, e.g., \hat{θ}ₘ=\hat{θ}ₘ_{ₚ} or \hat{θ}ₘ=\hat{θ}ₘ_{_{d}}. Alternatively, phase \hat{θ}ₘ_{ₚ} and \hat{θ}ₘ_{_{d}} can be combined, where \hat{θ}ₘ=α_{d}\hat{θ}ₘ_{_{d}}+αₚ\hat{θ}ₘ_{_{d}}, with α_{d} and αₚ being any non-negative numbers, e.g. 0, 0.2, 0.5, 0.8 or 1. In some examples, α_{d}+αₚ=1.

Once a phase difference between a symbol m and its previous symbol m−L is estimated, for example, in the manners described above and further herein, CFO can be estimated by

$$\hat{Δ} {f}_{m} = \frac{{\hat{θ}}_{m} + ( {∅}_{m} - {∅}_{m - L} )}{2 π {T}_{m}} , \qquad ( 7 )$$

where \hat{Δ}fₘ*2πTₘ is the accumulated phase rotation caused by CFO. Tₘ is the time duration based on symbol m and tracking gap L. For example, Tₘ=LT_{sym} for m≥L with T_{sym} being the OFDM symbol duration. In another example, Tₘ may refer to the time duration from the start of the LTF used for the channel estimation to the start of symbol m for m<L. The phase difference (Øₘ−Ø_{m-L}) represents a difference between initial phases of the two symbols. In some examples, the initial phase difference may be set to 0, and can be alternatively set to the difference between initial phases that are compensated at the start of the symbol m and m−L. In some examples, initial phase difference may be determined by

$${∅}_{m} - {∅}_{m - L} = {\sum }_{i = 3}^{L + 2} 2 π \tilde{Δ} {f}_{m - i} {T}_{sym} ,$$

where \hat{Δ}fₘ is the estimated CFO, which can be the CFO estimated at symbol m, i.e., \hat{Δ}fₘ, or can be the averaged estimated CFO as further described below. In this configuration, there may be an initial phase that has been corrected in time domain for each symbol.

In some embodiments, CFO can be determined based on estimated CFO averaged across symbols. For example, the averaged CFO can be \tilde{Δ}fₘ=β\tilde{Δ}fₘ₋₁+α\hat{Δ}fₘ, where β can be 1, or 1−α, or any other positive number, and α can be any positive number such as 0.125, 0.25, or 1.

As described above in FIG. 2 and further herein, CPE combiner (e.g., 206 in FIG. 2) may be bypassed upon certain network conditions being met (or not being met). For example, whereas CPE combiner is bypassed, CPE estimated at a symbol over pilot subcarriers can be used to compensate the data subcarriers in the same symbol. For example, let the received signal on data subcarrier k on receiver antenna j be denoted by y_{m,j}[k], CPE compensated data subcarrier can be calculated by

$${y}_{m , j}^{′} [ k ] = {y}_{m , j} [ k ] {e}^{- j {\hat{φ}}_{m}} , k ∈ data subcarriers . \qquad ( 8 )$$

Alternatively and/or additionally, the CPE can be combined across symbols. For example, CPE as denoted by \tilde{φ}ₘ may be estimated based on a combination of estimated phases of other symbols, for example, by weighted average expressed as:

$${\tilde{φ}}_{m} = {\sum }_{i = 0}^{N - 1} {w}_{i} {\hat{φ}}_{m - i}^{′} , \qquad ( 9 )$$

where wᵢ is the weight that can be any positive number. N is the number of symbols to combine, e.g., N=1, 2, 3, 5, or any suitable value. In some examples, the number of symbols for combining CPE may be determined based on one or more network conditions, e.g., the SNR and/or MCS. For example, when the SNR in a network is low, a larger number of symbols may be combined, thus a larger N. Conversely, a smaller value of N may be used for a higher SNR/MCS.

In the above Eq. (9), the common phase \hat{φ}′ₘ₋ᵢ can be calculated by

$${\hat{φ}}_{m - i}^{′} = {\hat{φ}}_{m - i} + {∅}_{m - i} - {∅}_{m} + i * 2 π \tilde{Δ} {f}_{m} {T}_{sym} \qquad ( 10 )$$

where the phase difference Øₘ₋ᵢ−Øₘ can be obtained as discussed above. For example, Øₘ₋ᵢ−Øₘ may be 0, or

$${\sum }_{a = 3}^{i + 2} - 2 π \tilde{Δ} {f}_{m - a} {T}_{sym} .$$

Having described CPE estimation and combination, the CPE compensated data subcarrier can be calculated based on the combined CPE estimate, such as

$${y}_{m , j}^{′} [ k ] = {y}_{m , j} [ k ] {e}^{- j {\tilde{φ}}_{m}} , k ∈ data subcarriers . \qquad ( 11 )$$

Eq. (11) is similar to Eq. (8) with the difference being that the combined estimated CPE for symbol m is used in Eq. (11), whereas no combination of estimated CPE across symbols is used in Eq. (8). By combining the CPE across symbols, the noise impact can be reduced, and thus, the accuracy of CPE estimation can be improved.

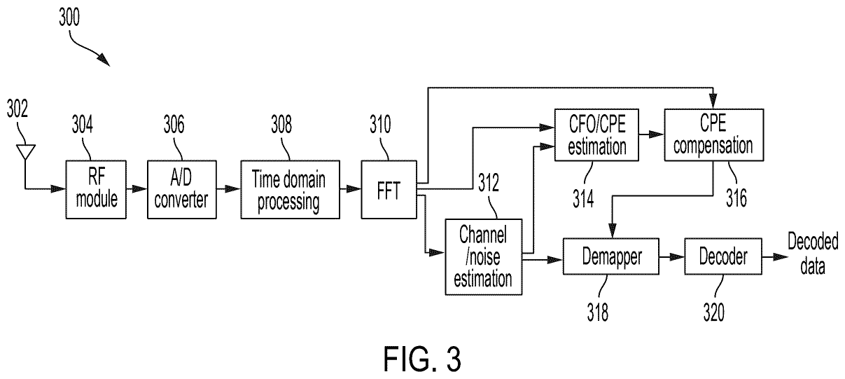

FIG. 3 is a diagram of an OFDM receiver 300 that implements various embodiments of CPE estimation, according to some embodiments. For example, a CFO estimation and/or CPE estimation unit 314 in OFDM receiver 300 may implement the example system 200 for CPE estimation and CFO estimation. As shown in FIG. 3, receiver 300 may additionally include an RF unit 304, an analog-to-digital (A/D) converter 306, a time domain processing unit 308, a time-to-frequency converter 310 (e.g., Fast Fourier Transforms (FFT) unit), a CPE compensation unit 316, a channel/noise estimation unit 312, a demapper unit 318, and/or a decoder unit 320.

In some embodiments, the RF unit 304 may receive wireless signal from one or more receiver antennas 302, and pass the signal to the A/D converter 306, which converts the analog signal to digital signal. Then the time domain processing unit 308 may perform the signal detection, timing synchronization and frequency synchronization for the digital signal. For example, a frame from a wireless channel may include continuous signals of symbols. Timing synchronization in time domain processing unit 308 may determine which field in the frame (packet) contain the training symbols (e.g., L-LTF, or STS) and extract the training symbols from the frame to be used for other components in the system.

After the time domain processing unit 308, the signal will pass through the FFT unit 310, which converts the time domain signal to frequency domain signal.

Channel/noise estimation unit 312 may estimate the channel and noise using the training symbols. The estimated channel responses and noise covariance may be provided to other components in the system. For example, the estimated channel response may be provided to CFO/CPE estimation unit 314, whereas estimated noise may be provided to the demapper unit 318 for signal demapping.

With further reference to FIG. 3, CFO/CPE estimation unit 314 may implement system 200 (FIG. 2) to estimate the CPE (and CFO) in the manners as described in FIG. 2. The estimated CPE will be used at CPE compensation unit 316 to compensate the received data signal. The data signal after CPE compensation will be passed to the demapper unit 318, to perform demapping using the estimated channels and noise. Then the demapped signal will be decoded in the decoder unit 320. Subsequent signals (e.g., L-SIG control signals, and data) in the wireless frame can be decoded in the decoder unit 320.

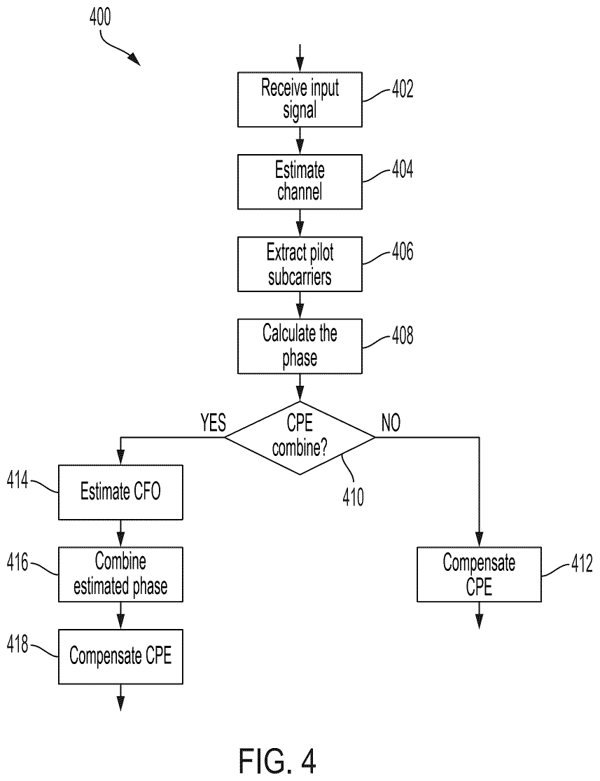

FIG. 4 is a flow diagram of an example process 400 for estimating CPE, according to some embodiments. In some embodiments, process 400 may be implemented in system 200 (FIG. 2) and/or receiver 300 (FIG. 3). Method 400 may include receiving input signal, at act 402. For example, the received input signal may include a sequence of symbols over a plurality of subcarriers, including pilot subcarriers and data subcarriers under a wireless protocol, such as OFDM. In some embodiments, the received signal may be in time domain or in frequency domain.

Method 400 may further include providing estimated channels based on one or more training symbols, at act 404. For example, act 404 may be performed using any suitable channel estimation techniques such as channel estimation described in FIGS. 2-3. Method 400 may further include extracting pilot subcarriers from the received symbols, at act 406. For example, act 406 may be performed in a similar manner as described in box 202 (FIG. 2). Method 400 may further include calculating the phase at act 408, which may be performed in a similar manner as in box 204 (FIG. 2). Various embodiments of estimating the phase (CPE) are described in embodiments in FIGS. 2 and 3, and description of these embodiments are not repeated herein.

Method 400 may further determine whether CPEs of multiple symbols are to be combined, at act 410. In some examples, act 410 may be implemented in the condition checker 214 (FIG. 2) in a similar manner as described in FIG. 2. For example, in response to determining to bypass CPE combination (e.g., in condition checker 214), method 400 may proceed to act 412 to compensate the CPE. An example for compensating the CPE is described above in Eq. (8).

In some embodiments, in response to determining to combine CPEs, method 400 may proceed to act 414 to estimate CFO. Act 414 may be implemented in a similar manner as described in CFO estimator 212 (FIG. 2). Method 400 may further proceed to act 416 and estimate CPE at a symbol based on combining CPEs of one or more other symbols. Act 416 may be implemented in a similar manner as described in CPE combiner 216 (FIG. 2). For example, estimated phases of one or more other symbols from act 408 may each be offset by a respective CFO estimated from act 414 before being combined at act 416. Method 400 may further proceed to act 418 to compensate the CPE using the combined CPE. An example for compensating the CPE is described above in Eq. (11).

Various embodiments described in the present disclosure provide advantages over existing system in that improved common phase error estimation may be obtained by combining CPEs across multiple symbols. Further advantages include offsetting the phases for multiple symbols with respective CFOs before they are combined for improved accuracy. Further, improved CFO estimation and improved CPE estimation are achieved via pilot subcarriers-based estimation, data subcarriers-based estimation, or a combination thereof. Additional advantages also include optimal selection of the CPE combination scheme described in the present disclosure when such combination is justified, e.g., under certain network conditions.

The various components and methods outlined herein may be implemented in hardware, e.g., one or more ICs, or coded as software that is executable on one or more processors that employ any one of a variety of operating systems or platforms. For example, any component or process in FIGS. 2-4 may be implemented in hardware, software, or in combination. Additionally, such software may be written using any of numerous suitable programming languages and/or programming or scripting tools, and also may be compiled as executable machine language code.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

1. An apparatus for communication in a wireless network, the apparatus comprising:
a common phase error (CPE) estimator configured to estimate a respective phase for each of a plurality of symbols received from the wireless network over a plurality of subcarriers;
a CPE combiner coupled to the CPE estimator and configured to, for a symbol of the plurality of symbols, determine a combined CPE based in part on estimated phases of one or more other symbols of the plurality of symbols; and
a CPE compensation unit coupled to the CPE estimator and configured to compensate phases of the plurality of symbols by the combined CPE.

2. The apparatus of claim 1, wherein the estimated phases of the one or more other symbols are each offset by a respective phase rotation.

3. The apparatus of claim 2 further comprising a carrier frequency offset (CFO) estimator configured to, for each of the one or more other symbols of the plurality of symbols, estimate the respective phase rotation based at least on a phase difference between the symbol and a previous symbol and a time elapsed between the symbol and the previous symbol.

4. The apparatus of claim 3, wherein the phase difference between the symbol and the previous symbol is estimated based at least in part on impact of channels over a first subset of the plurality of subcarriers being removed, the first subset including one or more data subcarriers.

5. The apparatus of claim 4, wherein the phase difference between the symbol and the previous symbol is estimated based additionally on impact of channels over a second subset of the plurality of subcarriers being removed, the second subset including one or more pilot subcarriers.

6. The apparatus of claim 5 further comprising a channel estimator configured to estimate the channels for use with removing the impact of channels over the plurality of subcarriers.

7. The apparatus of claim 3, wherein a respective estimated phase rotation for a symbol is determined based at least on estimated phase rotations of one or more symbols adjacent the symbol.

8. The apparatus of claim 3, wherein the previous symbol is selected such that a number of symbols between the symbol and the previous symbol is proportionally based on a signal-to-noise ratio or modulation and coding scheme index.

9. The apparatus of claim 1, wherein the combined CPE is determined based in part on a weighted average of the estimated phases of the one or more other symbols of the plurality of symbols.

10. The apparatus of claim 9, wherein a number of the one or more symbols of the plurality of symbols for determining the combined CPE is based on a signal-to-noise ratio or modulation and coding scheme index.

11. The apparatus of claim 1, further comprising a condition checker configured to:
determine whether one or more channel conditions in the wireless network are met; and
in response to determining that one or more channel conditions in the wireless network are met, bypass the CPE combiner.

12. The apparatus of claim 1, wherein the respective phase for each of a plurality of symbols is estimated based at least in part on impact of channels over a first subset of the plurality of subcarriers being removed, the first subset including one or more data subcarriers.

13. The apparatus of claim 12, wherein the respective phase for each of a plurality of symbols is estimated based additionally on impact of channels over a second subset of the plurality of subcarriers being removed, the second subset including one or more pilot subcarriers.

14. The apparatus of claim 13 further comprising a channel estimator configured to estimate the channels for use with removing the impact of channels over the plurality of subcarriers.

15. A method for communicating in a wireless network, the method comprising:
estimating a respective phase for each of a plurality of symbols received from the wireless network over a plurality of subcarriers;
for a symbol of the plurality of symbols, determining a combined CPE based in part on estimated phases of one or more other symbols of the plurality of symbols; and
compensating phases of the plurality of symbols by the combined CPE.

16. The method of claim 15, wherein the estimated phases of the one or more other symbols each being offset by a respective phase rotation.

17. The method of claim 16 further comprising:
for each of the one or more other symbols of the plurality of symbols, estimating the respective phase rotation based at least on a phase difference between the symbol and a previous symbol and a time elapsed between the symbol and the previous symbol;
wherein a respective estimated phase rotation for a symbol is determined based at least on estimated phase rotations of one or more symbols adjacent the symbol; and
wherein the previous symbol is selected such that a number of symbols between the symbol and the previous symbol is proportionally based on a signal-to-noise ratio or modulation and coding scheme index.

18. The method of claim 15, wherein:
the combined CPE is determined based in part on a weighted average of the estimated phases of the one or more other symbols of the plurality of symbols; and
a number of the one or more symbols of the plurality of symbols for determining the combined CPE is based on a signal-to-noise ratio or modulation and coding scheme index.

19. The method of claim 15, further comprising determining whether one or more channel conditions in the wireless network are met; and
in response to determining that one or more channel conditions in the wireless network are met, bypass the CPE combiner.

20. The method of claim 15, wherein the respective phase for each of a plurality of symbols is estimated based at least in part on impact of channels over a first subset of the plurality of subcarriers being removed, the first subset including one or more data subcarriers.
